(19) United States
(12) Patent Application Publication
(10) Pub. No.: US 2015/0359176 A1
(43) Pub. Date: Dec. 17, 2015

(54) Lawn mower Deck Opening Guard

(71) Applicant: Richard Alan Little, Salem, OH (US)

(72) Inventor: Richard Alan Little, Salem, OH (US)

(21) Appl. No.: 14/739,460

(22) Filed: Jun. 15, 2015

Related U.S. Application Data
(60) Provisional application No. 62/012,624, filed on Jun. 16, 2014.

(51) Int. Cl. A01D 34/82; A01D 34/81

(52) U.S. Cl. CPC A01D 34/828; A01D 34/81; A01D 2101/00

(57) ABSTRACT

A lawn mower deck opening guard includes an underbody plate, a reversed angle flange, a first mounting flange, and a second mounting flange. The reversed angle flange is connected to the underbody plate through a front free edge of the underbody plate while the first mounting flange and the second mounting flange are respectively connected to the underbody plate through a first fixed edge and a second fixed edge of the underbody plate. The lawn mower deck opening guard utilizes a plurality of fasteners to connect with a mower deck of a lawn mower through the first mounting flange and the second mounting flange. The reversed angle flange and the underbody plate are then able to improve the safety of the operator and control the debris expulsion during the mowing process.

The current application claims a priority to the U.S. Provisional Patent application Ser. No. 62/012,624 filed on Jun. 16, 2014.

### FIELD OF THE INVENTION

The present invention relates generally to the field of lawn mowers. More specifically, the present invention is a guard apparatus that attaches to the bottom surface of the lawn mower deck to control debris expulsion.

### BACKGROUND OF THE INVENTION

Many people utilize a lawn mower to cut and maintain their lawns to an even height. The lawn mowers generally employee two different styles of blade configuration to cut the grass. For example, lawn mower with a single blade that rotates about a single vertical axis are known as the rotary mowers while the lawn mowers with multiple blades that rotate about a single horizontal axis are known as the cylinder or reel mowers. Even though each different blade configurations has different advantages and disadvantages, some users prefer to use the rotary lawn mower while some users prefer to use reel lawn mowers. One of the main safety problem with all of these lawn mowers is that debris are ejected out of the bottom of the lawn mower during the mowing process. As a result, the lawn mower creates an unsafe work environment for the operator and the people around the lawn mower. In order to maintain a safe work environment, the operator of the lawn mower is required to wear safety glasses and other safety articles that protect the operator from the debris. However, operators sometime forget to wear these safety articles during the mowing process exposing them to the unsafe work environment. Additionally, the same safety articles are not always worn by people or workers who are nearby the lawn mower.

It is therefore an object of the present invention to introduce a guard apparatus for a lawn mower deck opening so that the discharged debris can be controlled through the usage of the present invention. More specifically, the present invention securely attaches with the bottom surface of the lawn mower deck as an attachment member to control the debris discharge. In addition to the debris controlled, the present invention also functions as safety cover for the lawn mower deck opening to prevent a foot slipping of operator into the cutting blade.

### BRIEF DESCRIPTION OF THE DRAWINGS

FIG. 1 is a top perspective view of the present invention.

FIG. 2 is a bottom perspective view of the present invention.

FIG. 3 is a top perspective view of the present invention, showing the edges of the underbody plate.

FIG. 4 is a top view of the present invention.

FIG. 5 is a rear side view of the present invention.

FIG. 6 is a top perspective view of the lawn mower, wherein the present invention is connected at the bottom of the lawn mower.

FIG. 7 is a bottom perspective view of the lawn mower, wherein the present invention is connected at the bottom of the lawn mower.

FIG. 8 is a side view of the lawn mower, wherein the present invention is connected at the bottom of the lawn mower.

### DETAIL DESCRIPTIONS OF THE INVENTION

All illustrations of the drawings are for the purpose of describing selected versions of the present invention and are not intended to limit the scope of the present invention.

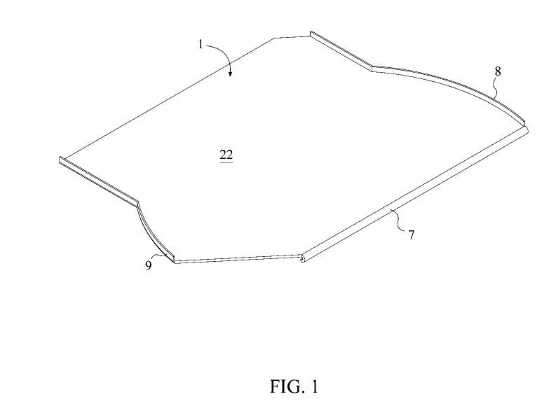

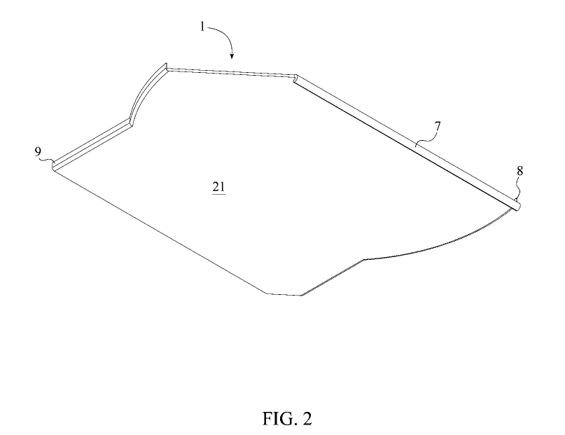

The present invention is a lawn mower deck opening guard that controls debris expulsion and prevents accidental foot slippage of the operator during the operation of a lawn mower 10. The present invention connects to the lawn mower 10 as a skid plate so that a mower deck opening 16 of the lawn mower 10 can be partially covered from the rear end. As a result of the placement of the present invention, the present invention is able to control the debris expulsion while providing a safe work environment to the operator and anyone else who is nearby the lawn mower 10. In reference to FIG. 1 and FIG. 2, the present invention comprises an underbody plate 1, a reversed angle flange 7, a first mounting flange 8, and a second mounting flange 9. In reference to the configuration of aforementioned components, the present invention is able to attain a safe work environment without limiting the efficiency of the lawn mower 10 or the existing functionality of the lawn mower 10. The present invention is made from high strength material that can withstand the constant usage of the lawn mower 10, wherein the high strength materials can include, but is not limited to steel, aluminum, plastic, or composite material.

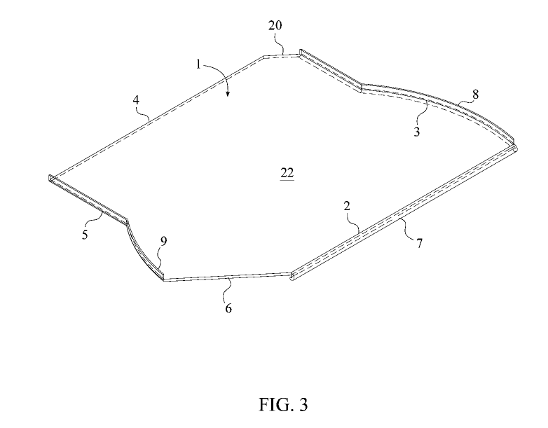

The underbody plate 1 that function as the main body of the present invention is utilized to cover the mower deck opening 16. In reference to FIG. 3, the underbody plate 1 comprises a front free edge 2, a first fixed edge 3, a rear free edge 4, a second fixed edge 5, a front chamfered edge 6, and a rear chamfered edge 20. More specifically, the shape of the underbody plate 1 is delineated by the parametrical positioning of the front free edge 2, the first fixed edge 3, the rear chamfered edge 20, the rear free edge 4, the second fixed edge 5, and the front chamfered edge 6. The shape of the underbody plate 1 is essential to the present invention as the underbody plate 1 is required to fully cover the rear end of the mower deck opening 16. The front free edge 2 and the rear free edge 4 are oppositely positioned of each other across the underbody plate 1 in such a way that the front free edge 2 and the rear free edge 4 are parallel to each other. The first fixed edge 3 is perimetrically positioned with the front free edge 2 as the rear chamfered edge 20 is perimetrically positioned with the first fixed edge 3. The rear chamfered edge 20, which provides an empty space between the first fixed edge 3 and the rear free edge 4 so that the existing components of the lawn mower 10 can coexists with the present invention, is perimetrically positioned with the first fixed edge 3. The rear free edge 4 is perimetrically positioned with the rear chamfered edge 20 while the second fixed edge 5 and the front chamfered edge 6 are oppositely positioned from the first fixed edge 3 across the underbody plate 1. In order to attain the shape of the underbody plate 1, the second fixed edge 5 is perimetrically positioned with the rear free edge 4, and the front chamfered edge 6 is perimetrically positioned in between the second fixed edge 5 and the front free edge 2. The first fixed edge 3 and the second fixed edge 5 are shaped to match the existing shape of a deck rim 13 of the lawn mower 10 so that the underbody plate 1 can be placed flush against the mower deck opening 16. In other words, when the underbody plate 1 is placed against the deck rim 13, the first fixed edge 3 and the second fixed edge 5 are adjacently positioned with the deck rim 13. As a result, the front free edge 2 and the front chamfered edge 6 are positioned across the mower deck opening 16 adjacent to the rotational and vertical axis of a cutting blade 14 of the lawn mower 10 while the rear free edge 4 is positioned adjacent to a rear wheel assembly 15 of the lawn mower 10.

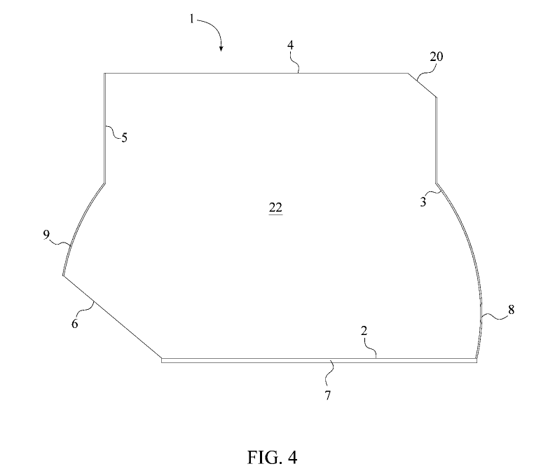

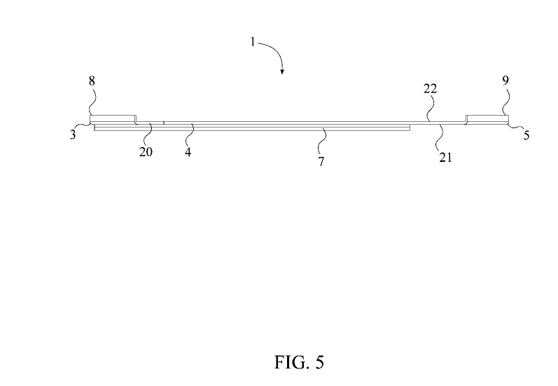

The reversed angle flange 7 functions as a stopper in the event if the operator's foot slips into the mower deck opening 16. Additionally, the reversed angle flange 7 allows the lawn mower 10 to smoothly glide over the already cut lawn without damaging the freshly cut ends of the grass. In reference to FIG. 3-5, the reversed angle flange 7 is connected to the underbody plate 1 through the front free edge 2. More specifically, the reversed angle flange 7 is adjacently positioned with a bottom surface 21 of the underbody plate 1 so that the reversed angle flange 7 can function as the stopper while being able to glide over the lawn. Since the reversed angle flange 7 extends toward the bottom surface 21 of the underbody plate 1 and adjacently positioned with the cutting blade 14, the reversed angle flange 7 does not come into the contact with the cutting blade 14 or any other moving parts of the lawn mower 10.

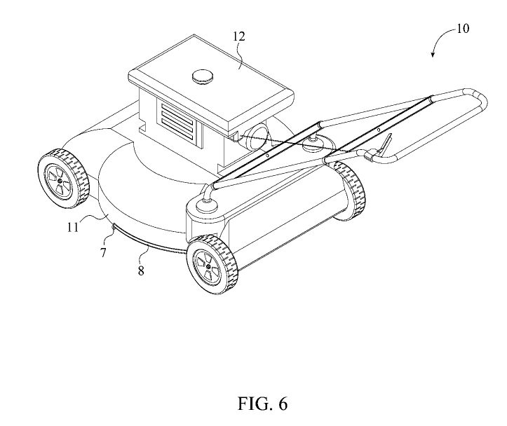

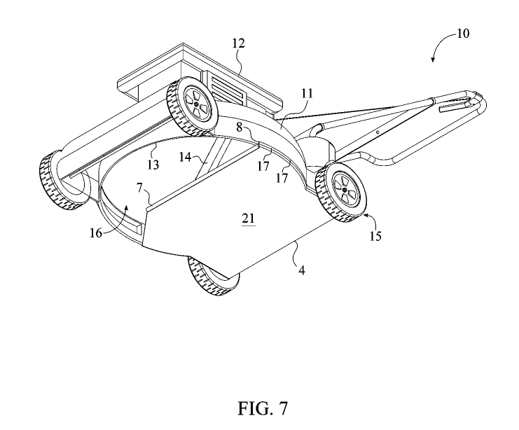

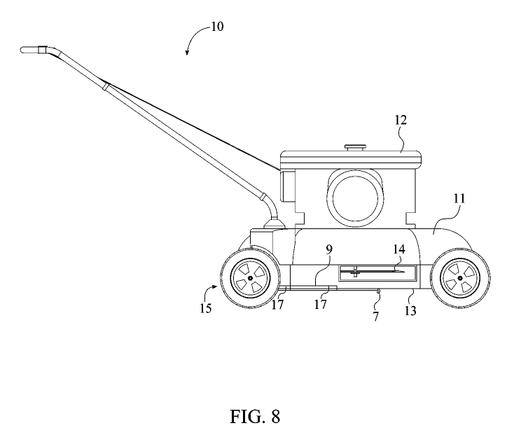

The first mounting flange 8 and the second mounting flange 9 function as the connecting members of the present invention. In reference to FIG. 3-5, the first mounting flange 8 is connected to the underbody plate 1 through the first fixed edge 3 and the second mounting flange 9 is connected to the underbody plate 1 through the second fixed edge 5. The first mounting flange 8 and the second mounting flange 9 are oppositely extended from the reversed angle flange 7 about the underbody plate 1 so that the present invention can be properly secured to a mower deck 11 by a plurality of fasteners 17 as shown in FIG. 6-8. In other words, the first mounting flange 8 and the second mounting flange 9 are perpendicularly positioned with a top surface 22 of the underbody plate 1 so that the top surface 22 of the underbody plate 1 can be pressed against the deck rim 13. When the underbody plate 1 is adjacently positioned with the deck rim 13, opposite of a mower engine 12 of the lawn mower 10, the underbody plate 1 is perimetrically aligned with the mower deck 11 by the first mounting flange 8 and the second mounting flange 9. In order to provide the secure connection, the plurality of fasteners 17 is utilized within the first mounting flange 8 and the second mounting flange 9 as the interconnecting members so that the present invention can be secured to the mower deck 11. The plurality of fasteners 17 can include, but is not limited to, screws, t-strap fasteners, retaining rings, or any other type of fastening hardware as long as the secure connection between the present invention and the lawn mower 10 can be achieved.

In order to accommodate for rear discharging lawn mowers 10, the rear free edge 4 is positioned flush with the deck rim 13 so that the debris expulsion can take place within the rear end the lawn mower 10 as the rear free edge 4 does not block the rear debris discharging duct of the lawn mower 10. In order to accommodate for side discharging lawn mowers 10, the front chamfered edge 6 is positioned adjacent with the side debris discharging duct of the lawn mower 10 so that the debris can exit through the front chamfered edge 6 and into the side debris discharge duct without limiting the efficiency of the lawn mower 10.

Although the invention has been explained in relation to its preferred embodiment, it is to be understood that many other possible modifications and variations can be made without departing from the spirit and scope of the invention as hereinafter claimed.

What is claimed is:

1. A lawn mower deck opening guard comprises:
an underbody plate;
a reversed angle flange;
a first mounting flange;
a second mounting flange;
the underbody plate comprises a front free edge, a first fixed edge, a rear free edge, a second fixed edge, a front chamfered edge, and a rear chamfered edge;
the front free edge, the first fixed edge, the rear free edge, the second fixed edge, a front chamfered edge, and a rear chamfered edge being perimetrically positioned around the underbody plate;
the reversed angle flange being connected to the underbody plate through the front free edge;
the first mounting flange being connected to the underbody plate through the first fixed edge;
the second mounting flange being connected to the underbody plate through the second fixed edge; and
the reversed angle flange being oppositely extended of the first mounting flange and the second mounting flange, about the underbody plate.

2. The lawn mower deck opening guard as claimed in claim 1 comprises:
the front free edge and the rear free edge being oppositely positioned of each other across the underbody plate;
the front free edge and the rear free edge being positioned parallel to each other;
the first fixed edge being perimetrically positioned with front free edge;
the rear chamfered edge being perimetrically positioned with the first fixed edge;
the rear free edge being perimetrically positioned with the rear chamfered edge;
the second fixed edge and the front chamfered edge being oppositely positioned from the first fixed edge across the underbody plate;
the second fixed edge being perimetrically positioned with the rear free edge; and
the front chamfered edge being perimetrically positioned in between the second fixed edge and the front free edge.

3. The lawn mower deck opening guard as claimed in claim 1 comprises:
the reversed angle flange being adjacently positioned with a bottom surface of the underbody plate; and
the first mounting flange and the second mounting flange being perpendicularly positioned with a top surface of the underbody plate.

4. The lawn mower deck opening guard as claimed in claim 1 comprises:
the underbody plate being adjacently positioned with a deck rim of a lawn mower, opposite of a mower engine of the lawn mower; and
the underbody plate being perimetrically aligned with a mower deck of the lawn mower by the first mounting flange and the second mounting flange.

5. The lawn mower deck opening guard as claimed in claim 4 comprises:
the first fixed edge and the second fixed edge being adjacently positioned with the deck rim;
the first mounting flange and the second mounting flange being connected with the mower deck by a plurality of fasteners;
the front free edge, the chamfered edge, and the reversed angle flange being adjacently positioned with a cutting blade of the lawn mower; and
the rear free edge being adjacently positioned with a rear wheel assembly of the lawn mower.

6. A lawn mower deck opening guard comprises:
an underbody plate;
a reversed angle flange;
a first mounting flange;
a second mounting flange;
the underbody plate comprises a front free edge, a first fixed edge, a rear free edge, a second fixed edge, a front chamfered edge, and a rear chamfered edge;
the front free edge, the first fixed edge, the rear free edge, the second fixed edge, a front chamfered edge, and a rear chamfered edge being perimetrically positioned around the underbody plate;
the reversed angle flange being connected to the underbody plate through the front free edge;
the first mounting flange being connected to the underbody plate through the first fixed edge;
the second mounting flange being connected to the underbody plate through the second fixed edge;
the reversed angle flange being oppositely extended of the first mounting flange and the second mounting flange, about the underbody plate;
the reversed angle flange being adjacently positioned with a bottom surface of the underbody plate; and
the first mounting flange and the second mounting flange being perpendicularly positioned with a top surface of the underbody plate.

7. The lawn mower deck opening guard as claimed in claim 6 comprises:
the front free edge and the rear free edge being oppositely positioned of each other across the underbody plate;
the front free edge and the rear free edge being positioned parallel to each other;
the first fixed edge being perimetrically positioned with front free edge;
the rear chamfered edge being perimetrically positioned with the first fixed edge;
the rear free edge being perimetrically positioned with the rear chamfered edge;
the second fixed edge and the front chamfered edge being oppositely positioned from the first fixed edge across the underbody plate;
the second fixed edge being perimetrically positioned with the rear free edge; and
the front chamfered edge being perimetrically positioned in between the second fixed edge and the front free edge.

8. The lawn mower deck opening guard as claimed in claim 6 comprises:
the underbody plate being adjacently positioned with a deck rim of a lawn mower, opposite of a mower engine of the lawn mower; and
the underbody plate being perimetrically aligned with a mower deck of the lawn mower by the first mounting flange and the second mounting flange.

9. The lawn mower deck opening guard as claimed in claim 8 comprises:
the first fixed edge and the second fixed edge being adjacently positioned with the deck rim;
the first mounting flange and the second mounting flange being connected with the mower deck by a plurality of fasteners;
the front free edge, the chamfered edge, and the reversed angle flange being adjacently positioned with a cutting blade of the lawn mower; and
the rear free edge being adjacently positioned with a rear wheel assembly of the lawn mower.

10. A lawn mower deck opening guard comprises:
an underbody plate;
a reversed angle flange;
a first mounting flange;
a second mounting flange;
the underbody plate comprises a front free edge, a first fixed edge, a rear free edge, a second fixed edge, a front chamfered edge, and a rear chamfered edge;
the front free edge, the first fixed edge, the rear free edge, the second fixed edge, a front chamfered edge, and a rear chamfered edge being perimetrically positioned around the underbody plate;
the reversed angle flange being connected to the underbody plate through the front free edge;
the first mounting flange being connected to the underbody plate through the first fixed edge;
the second mounting flange being connected to the underbody plate through the second fixed edge;
the reversed angle flange being oppositely extended of the first mounting flange and the second mounting flange, about the underbody plate;
the reversed angle flange being adjacently positioned with a bottom surface of the underbody plate;
the first mounting flange and the second mounting flange being perpendicularly positioned with a top surface of the underbody plate; and
the underbody plate being adjacently positioned with a deck rim of a lawn mower, opposite of a mower engine of the lawn mower.

11. The lawn mower deck opening guard as claimed in claim 10 comprises:
the front free edge and the rear free edge being oppositely positioned of each other across the underbody plate;
the front free edge and the rear free edge being positioned parallel to each other;
the first fixed edge being perimetrically positioned with front free edge;
the rear chamfered edge being perimetrically positioned with the first fixed edge;
the rear free edge being perimetrically positioned with the rear chamfered edge;
the second fixed edge and the front chamfered edge being oppositely positioned from the first fixed edge across the underbody plate;
the second fixed edge being perimetrically positioned with the rear free edge; and
the front chamfered edge being perimetrically positioned in between the second fixed edge and the front free edge.

12. The lawn mower deck opening guard as claimed in claim 10 comprises:
the underbody plate being perimetrically aligned with a mower deck of the lawn mower by the first mounting flange and the second mounting flange.

13. The lawn mower deck opening guard as claimed in claim 12 comprises:
the first fixed edge and the second fixed edge being adjacently positioned with the deck rim;
the first mounting flange and the second mounting flange being connected with the mower deck by a plurality of fasteners;
the front free edge, the chamfered edge, and the reversed angle flange being adjacently positioned with a cutting blade of the lawn mower; and
the rear free edge being adjacently positioned with a rear wheel assembly of the lawn mower.
